(19) United States
(12) Patent Application Publication
(10) Pub. No.: US 2021/0264766 A1
(43) Pub. Date: Aug. 26, 2021

(54) ANTI-LOST METHOD AND SYSTEM FOR WEARABLE TERMINAL AND WEARABLE TERMINAL

(71) Applicant: JRD COMMUNICATION (SHENZHEN) LTD, Shenzhen, Guangdong (CN)

(72) Inventor: Yan Yang, Shenzhen, Guangdong (CN)

(73) Assignee: JRD COMMUNICATION (SHENZHEN) LTD, Shenzhen, Guangdong (CN)

(21) Appl. No.: 16/316,037

(22) PCT Filed: Apr. 28, 2017
(86) PCT No.: PCT/CN2017/082379

§ 371 Date: Jan. 7, 2019

(30) Foreign Application Priority Data
Sep. 29, 2016 (CN) 201610870417.2

(51) Int. Cl. G08B 21/24; G06F 21/88; G06F 21/32; G06K 9/00; G06F 1/16

(52) U.S. Cl. CPC G08B 21/24; G06F 21/88; G06F 21/32; G06K 2009/00939; G06F 1/163; G06F 2221/2111; G06K 2009/00932; G06K 9/00885

(57) ABSTRACT

The present disclosure discloses an anti-lost method and system for a wearable terminal and a wearable terminal. The method includes: obtaining a vein image of a current user of the wearable terminal; determining whether the vein image matches one of authorized vein images; and sending reminding information to other terminals associated with the wearable terminal when the vein image does not match any one of the authorized vein images. The reminding information at least includes current geographical location information of the wearable terminal.

### TECHNICAL FIELD

The present disclosure relates to the field of smart terminal communication technologies, and more particularly, to an anti-lost method and system for a wearable terminal and a wearable terminal.

### BACKGROUND

With the development of technologies, smart terminals have gradually become common tools in people's lives and work.

Among the smart terminals, a wearable terminal is more and more popular because it is rich in function, convenient to carry, and can record a user's physical data in real time. However, the wearable terminal is generally small in size and easy to disassemble, which makes the wearable terminal easy to lose, and the user often cannot find it in time, thereby resulting in loss of the user's property.

### SUMMARY

An objective of the present disclosure is to provide an anti-lost method and system for a wearable terminal and a wearable terminal, which can timely inform a user when the wearable terminal is lost or stolen.

To solve the above technical problem, the present disclosure proposes a technical solution as below: there is provided an anti-lost system for a wearable terminal, including a wearable terminal and other terminals associated with the wearable terminal. The wearable terminal is configured to obtain a vein image of a current user, determine whether the vein image matches one of authorized vein images, and send reminding information to the other terminals when the vein image does not match any one of the authorized vein images, wherein the reminding information at least includes current geographical location information of the wearable terminal. The wearable terminal is configured to obtain the vein image of the current user and determine whether the vein image matches one of authorized vein images specifically includes: obtaining a corresponding vein characteristic value from the vein image, and determining whether the vein characteristic value of the vein image matches a vein characteristic value of one of the authorized vein images. The other terminals are configured to receive the reminding information and make a corresponding response based on a preset response mode.

The present disclosure also proposes another technical solution as below: there is provided a wearable terminal, which may include: a first obtaining module, a first determining module and a first sending module. The first obtaining module, configured to obtain a vein image of a current user of the wearable terminal. The first determining module, configured to determine whether the obtained vein image matches one of authorized vein images. The first sending module, configured to send reminding information to other terminals associated with the wearable terminal when a determination result of the first determining module indicates that the vein image does not match any one of the authorized vein images, wherein the reminding information at least includes current geographical location information of the wearable terminal.

The present disclosure also proposes still another technical solution as below: there is provided an anti-lost method for a wearable terminal, the method may include: obtaining a vein image of a current user of the wearable terminal; determining whether the vein image matches one of authorized vein images; and sending reminding information to other terminals associated with the wearable terminal when the vein image does not match any one of the authorized vein images; wherein the reminding information at least includes current geographical location information of the wearable terminal.

Beneficial effects of the present disclosure are as below: different from the related art, according to the present disclosure, a vein image of a current user of the wearable terminal is obtained. It is determined whether the vein image matches one of authorized vein images. Reminding information is to other terminals associated with the wearable terminal if the vein image does not match any one of the authorized vein images. The reminding information at least includes current geographical location information of the wearable terminal. It is determined whether a current user of a terminal is an authorized user based on a vein image of the current user, so as to determine whether the terminal is lost. The authorized user is timely informed when the terminal is lost, and current geographical location information of the wearable terminal is sent to the authorized user, such that the authorized user can timely know that the terminal is lost or stolen, and can timely get the wearable terminal back based on the received geographical location information.

### BRIEF DESCRIPTION OF THE DRAWINGS

FIG. 1 is a schematic flow diagram of an anti-lost method for a wearable terminal according to a first embodiment of the present disclosure.

FIG. 2 is a schematic flow diagram of an anti-lost method for a wearable terminal according to a second embodiment of the present disclosure.

FIG. 3 is a schematic flow diagram of an anti-lost method for a wearable terminal according to a third embodiment of the present disclosure.

FIG. 4 is a function module diagram of an anti-lost system for a wearable terminal according to a first embodiment of the present disclosure.

FIG. 5 is a function module diagram of an anti-lost system for a wearable terminal according to a second embodiment of the present disclosure.

FIG. 6 is a function module diagram of an anti-lost system for a wearable terminal according to a third embodiment of the present disclosure.

FIG. 7 is a schematic structural diagram of an anti-lost system for a wearable terminal according to an embodiment of the present disclosure.

### DETAILED DESCRIPTION

In order that those skilled in the art better understand the technical solution of the present disclosure, an anti-lost method and system for a wearable terminal and a wearable terminal provided by the present disclosure are further described in detail below with reference to the accompanying drawings and embodiments.

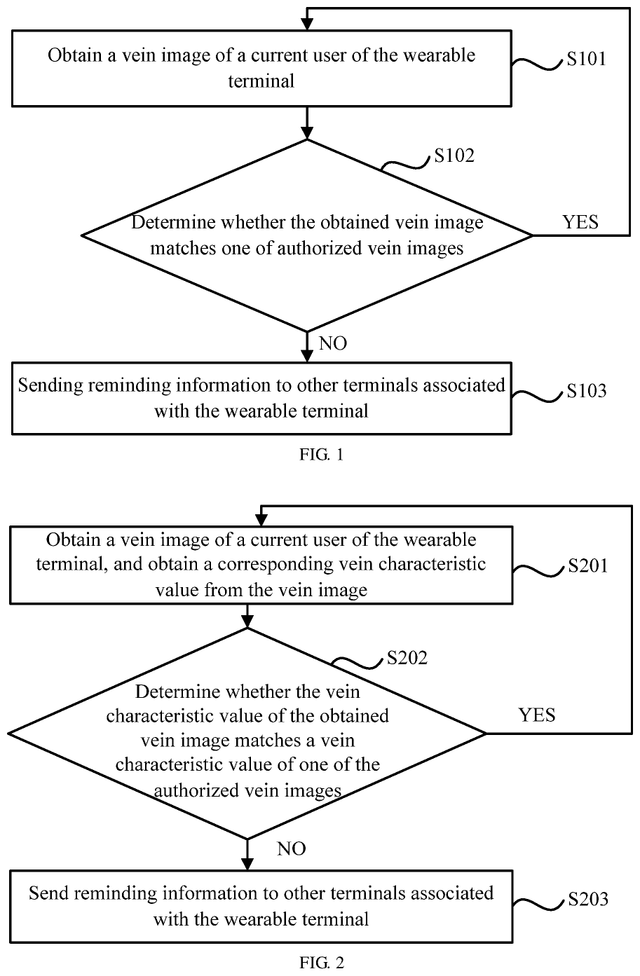

Referring to FIG. 1, a schematic flow diagram of an anti-lost method for a wearable terminal according to a first embodiment of the present disclosure is illustrated, the method may include the following blocks.

In block S101, a vein image of a current user of the wearable terminal may be obtained.

Due to its manner of wearing, the wearable terminal may obtain some physiological data (for example, heartbeat and pulse, etc.) of the user via a sensor. As a biological recognition, the vein recognition is high in accuracy, non-copyable, and high in security. An ID of the current user may be recognized by obtaining the vein image of the current user by using the wearable terminal.

In block S102, whether the obtained vein image matches one of authorized vein images may be determined.

It may be determined whether the current user is an authorized user by matching the obtained vein image of the current user with one of the authorized vein images. The authorized vein images are vein images of persons authorized by the user to use the wearable terminal. The user stores vein images of persons authorized by the user to use the wearable terminal into the wearable terminal, and these stored vein images are the authorized vein images.

The user may obtain the vein images of persons authorized to use the wearable terminal directly via a sensor on the wearable terminal, or may obtain the vein images of persons authorized to use the wearable terminal via an external vein detector or an infrared camera.

In block S103, reminding information may be sent to other terminals associated with the wearable terminal when in block S102 it is determined that the vein image does not match any one of the authorized vein images.

When the wearable terminal is in use, the user may associate the wearable terminal with other terminals of the user, or associate the wearable terminal with terminals of the user's family members or friends. At this moment, the terminals associated with the wearable terminal are the other terminals associated with the wearable terminal. For example, if the user associates the wearable terminal with a mobile phone of the user, the mobile phone of the user is the other terminal associated with the wearable terminal.

If the vein image of the current user does not match any one of the authorized vein images, this indicates that the current user is not the person authorized to use the wearable terminal. That is, the wearable terminal may be likely stolen or lost. At this moment, the reminding information is sent to the other terminals associated with the wearable terminal to timely inform the user that the wearable terminal may be likely lost. The reminding information may at least include current geographical location information of the wearable terminal, such that the user may get the wearable terminal back based on the address location information. In this embodiment, the reminding information may further include the obtained vein image.

Here the vein image mismatching any one of the authorized vein images means that a matching degree between the vein image and any one of the authorized vein images is lower than a preset threshold, which is not specifically limited in this embodiment and may be set as 90%, 80% or 60%.

In this embodiment it is determined whether the current user of the terminal is an authorized user based on the vein image of the current user, so as to determine whether the terminal is lost. The authorized user is timely informed if the terminal is lost, and current geographical location information of the wearable terminal is sent to the authorized user, such that the authorized user can timely know that the terminal is stolen or lost, and may timely get the wearable terminal back based on the received geographical location information.

Referring to FIG. 2, a schematic flow diagram of an anti-lost method for a wearable terminal according to a second embodiment of the present disclosure is illustrated. The method may include the following blocks.

In block S201, a vein image of a current user of the wearable terminal, and a corresponding vein characteristic value may be obtained from the vein image.

The block of obtaining the vein image of the current user of the wearable terminal in this embodiment may be the same as the anti-lost method according to the first embodiment as shown in FIG. 1, and thus its detailed description is omitted here.

After the vein image of the current user is obtained, a vein characteristic value of the vein image is extracted by using an image analysis method such as filtering, image binarization, thinning and so on to obtain the corresponding vein characteristic value. By way of characteristic data, the vein characteristic value represents the portion in the vein image having a comparative significance, enhances matching accuracy, and shortens matching time.

In block S202, whether the vein characteristic value of the obtained vein image matches a vein characteristic value of one of the authorized vein images may be determined.

In this embodiment, the ID of the current user is determined by matching the vein characteristic value of the vein image of the current user with the vein characteristic value of one of the vein images of the authorized users. The vein characteristic values of the authorized vein images are the vein characteristic values obtained by analyzing the vein images of the persons authorized by the user to use the wearable terminal.

In block S203, reminding information may be sent to other terminals associated with the wearable terminal when in block S202 it is determined that the vein characteristic value of the obtained vein image does not match the vein characteristic value of any one of the authorized vein images.

This block may be the same as block S103 of the anti-lost method according to the first embodiment as shown in FIG. 1, and thus its detailed description is omitted here.

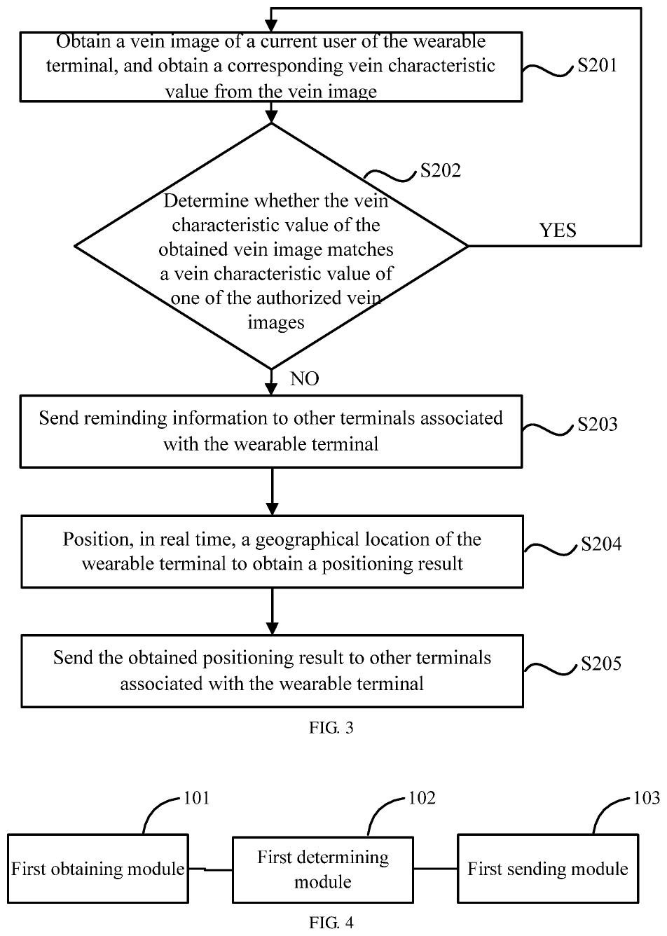

Further, as shown in FIG. 3, after block S203, the method may further include the following blocks:

In block S204, a geographical location of the wearable terminal may be positioned, in real time, to obtain a positioning result.

In addition to obtaining the current geographical location information of the wearable terminal in block S203, a positioning device may be remained on to position, in real time, the geographical location of the wearable terminal to obtain the positioning result of the wearable terminal.

In block S205, the obtained positioning result may be sent to other terminals associated with the wearable terminal.

After the reminding information is sent to the other terminals associated with the wearable terminal in block S203, the positioning result obtained in block S204 is sent, in real time, to other terminals associated with the wearable terminal, such that the user may get the wearable terminal back based on the positioning result.

Block S204 and block S205 also may be combined with the anti-lost method according to the first embodiment as shown in FIG. 1, and block S204 and block S205 may be executed in sequence after block S103.

Referring to FIG. 4, a function module diagram of an anti-lost system for a wearable terminal according to a first embodiment of the present disclosure is illustrated, wherein the system may include: a first obtaining module 101, a first determining module 102 and a first sending module 103.

The first obtaining module 101 is configured to obtain a vein image of a current user of the wearable terminal.

The first determining module 102 is configured to determine whether the obtained vein image matches one of authorized vein images.

The first sending module 103 is configured to send reminding information to other terminals associated with the wearable terminal when a determination result of the determining module 102 indicates that the vein image does not match any one of the authorized vein images. The reminding information may at least include current geographical location information of the wearable terminal.

Modules of the anti-lost system for the wearable terminal according to the first embodiment of the present disclosure as shown in FIG. 4 are corresponding to blocks of the anti-lost method according to the first embodiment as shown in FIG. 1, and thus their detailed descriptions are omitted here.

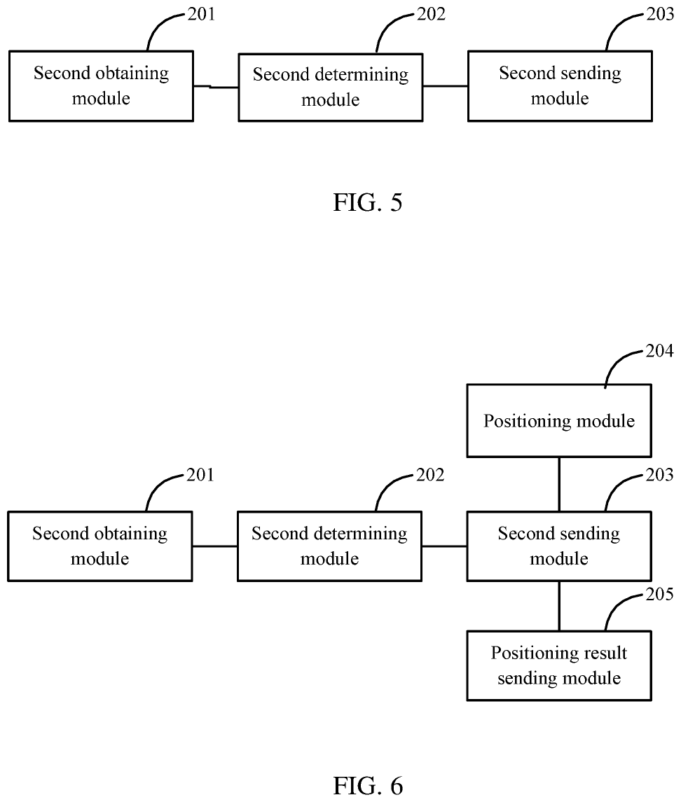

Referring to FIG. 5, a function module diagram of an anti-lost system for a wearable terminal according to a second embodiment of the present disclosure is illustrated, wherein the system may include: a second obtaining module 201, a second determining module 202 and a second sending module 203.

The second obtaining module 201 is configured to obtain a vein image of a current user of the wearable terminal, and obtain a corresponding vein characteristic value from the vein image.

The second determining module 202 is configured to determine whether the vein characteristic value of the obtained vein image matches a vein characteristic value of one of the authorized vein images.

The second sending module 203 is configured to send reminding information to other terminals associated with the wearable terminal.

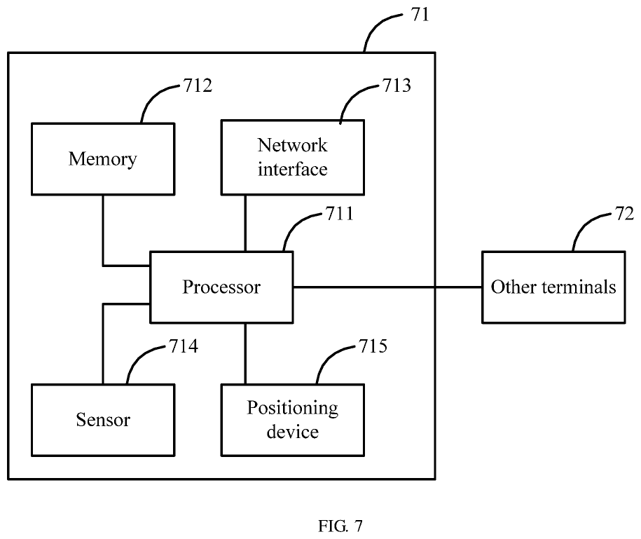

Further, as shown in FIG. 6, the anti-lost system for the wearable terminal according to the second embodiment of the present disclosure may further include: a positioning module 204 and a positioning result sending module 205.

The positioning module 204 is configured to obtain current geographical location information of the wearable terminal, and position, in real time, a geographical location of the wearable terminal to obtain a positioning result.

The positioning result sending module 205 is configured to send the obtained positioning result to other terminals associated with the wearable terminal.

Modules of the anti-lost system for the wearable terminal according to the second embodiment of the present disclosure as shown in FIG. 5 and FIG. 6 are corresponding to blocks of the anti-lost method according to the second embodiment as shown in FIG. 2 and FIG. 3, and thus their detailed descriptions are omitted here.

The present disclosure also provides embodiments of a wearable terminal, which includes the embodiments of the anti-lost system for the wearable terminal as shown in FIG. 4, FIG. 5 or FIG. 6.

Referring to FIG. 7, a schematic structural diagram of an anti-lost system for a wearable terminal according to an embodiment of the present disclosure is illustrated. The system may include a wearable terminal 71 and other terminals 72 associated with the wearable terminal 71.

The wearable terminal 71 may include a processor 711, a memory 712, a network interface 713, a sensor 714, and a positioning device 715.

The processor 711 may be respectively coupled to the memory 712, the network interface 713, the sensor 714 and the positioning device 715.

The memory 712 may be configured to store an operation instruction executed by the processor 711, authorized vein images and/or vein characteristic values of the authorized vein images prestored by an operating system and a user.

The network interface 713 may be connected to a network, such that the wearable terminal 71 may carry out network communication.

The sensor 714 may be configured to obtain a vein image of a current user of the wearable terminal 71.

The positioning device 715 may be configured to position the wearable terminal 71 to obtain current geographical location information of the wearable terminal 71 and a real-time positioning result.

The processor 711 may be configured to: obtain a vein image of a current user via the sensor 714; determine whether the obtained vein image matches one of the authorized vein images stored in the memory 712; and send reminding information to the other terminals 72 via the network interface 713 when the vein image does not match any one of the authorized vein images; wherein the reminding information may at least include current geographical location information of the wearable terminal 71 obtained by the positioning device 715.

The other terminals 72 associated with the wearable terminal 71 may be configured to: receive the reminding information sent from the wearable terminal 71 and make a corresponding response based on a preset response mode.

In this embodiment, the making a corresponding response based on a preset response mode may include: ringing, vibrating and/or flickering based on a preset ring mode, a preset vibration mode and/or a preset flickering mode. The user is reminded of the wearable terminal being likely lost or stolen by way of ringing, vibrating and/or flickering.

Further, the processor 711 of the wearable terminal 71 may be also configured to: position, in real time, a geographical location of the wearable terminal 71 via the positioning device 715 to obtain a positioning result and send the positioning result to the other terminals 72.

The other terminals 72 associated with the wearable terminal 71 receive the positioning result and display the positioning result on a display interface. In this way, the user may likely get the wearable terminal back based on the positioning result.

The above are merely embodiments of the present disclosure and are not intended to limit the patent scope of the present disclosure. Any modifications of equivalent structure or equivalent process made on the basis of the contents of the description and accompanying drawings of the present disclosure or directly or indirectly applied to other related technical fields shall similarly fall within the scope of patent protection of the present disclosure.

1. An anti-lost system for a wearable terminal, comprising a wearable terminal and other terminals associated with the wearable terminal;
the wearable terminal configured to obtain a vein image of a current user, determine whether the vein image matches one of authorized vein images; and send reminding information to the other terminals when the vein image does not match any one of the authorized vein images; wherein the reminding information at least comprises current geographical location information of the wearable terminal;
wherein the wearable terminal configured to obtain the vein image of the current user and determine whether the vein image matches one of authorized vein images specifically comprises: obtaining a corresponding vein characteristic value from the vein image, and determining whether the vein characteristic value of the vein image matches a vein characteristic value of one of the authorized vein images; and
the other terminals configured to receive the reminding information and make a corresponding response based on a preset response mode.

2. The system according to claim 1, wherein the making a corresponding response based on a preset response mode comprises:
ringing, vibrating and/or flickering based on a preset ring mode, a preset vibration mode and/or a preset flickering mode.

3. The system according to claim 1, after the wearable terminal sends reminding information to the other terminals, further comprising:
positioning, in real time, a geographical location of the wearable terminal to obtain a positioning result and sending the positioning result to the other terminals; and
receiving the positioning result and displaying the positioning result on a display interface by the other terminals.

4-6. (canceled)

7. An anti-lost method for a wearable terminal, comprising:
obtaining a vein image of a current user of the wearable terminal;
determining whether the vein image matches one of authorized vein images; and
sending reminding information to other terminals associated with the wearable terminal when the vein image does not match any one of the authorized vein images;
wherein the reminding information at least comprises current geographical location information of the wearable terminal.

8. The anti-lost method according to claim 7, wherein the obtaining a vein image of a current user of the wearable terminal comprises:
obtaining a corresponding vein characteristic value from the vein image;
the determining whether the vein image matches one of authorized vein images comprises:
determining whether the vein characteristic value of the vein image matches a vein characteristic value of one of the authorized vein images.

9. The anti-lost method according to claim 7, after the sending reminding information to other terminals associated with the wearable terminal, the method further comprising:
positioning, in real time, a geographical location of the wearable terminal to obtain a positioning result; and
sending the positioning result to the other terminals.

10. A wearable terminal, comprising:
a sensor configured to obtain a vein image of a current user of the wearable terminal;
a memory configured to store an operation instruction, authorized vein images and/or vein characteristic values of the authorized vein images prestored by an operating system and a user; and
a processor coupled to the memory and configured to:
determine whether the obtained vein image matches one of the authorized vein images stored in the memory; and send reminding information to the other terminals when the vein image does not match any one of the authorized vein images; wherein the reminding information is at least comprise current geographical location information of the wearable terminal.

11. The wearable terminal according to claim 10, wherein the processor is further configured to:
obtain a corresponding vein characteristic value from the vein image; and
determine whether the vein characteristic value of the vein image matches a vein characteristic value of one of the authorized vein images.

12. The wearable terminal according to claim 10, further comprising:
a positioning device configured to position the wearable terminal to obtain current geographical location information of the wearable terminal and a real-time positioning result; and
a positioning result sending device configured to send the obtained positioning result to other terminals associated with the wearable terminal.

13. The wearable terminal according to claim 10, further comprising:
a network interface connected to a network and configured to carry out network communication.

14. The system according to claim 1, wherein the vein image does not match any one of the authorized vein images means that a matching degree between the vein image and any one of the authorized vein images is lower than a preset threshold.

15. The system according to claim 14, wherein the preset threshold is 90%, 80% or 60%.

16. The anti-lost method according to claim 7, wherein the vein image mismatching any one of the authorized vein images means that a matching degree between the vein image and any one of the authorized vein images is lower than a preset threshold.

17. The anti-lost method according to claim 16, wherein the preset threshold is 90%, 80% or 60%.

18. The wearable terminal according to claim 10, wherein the vein image does not match any one of the authorized vein images means that a matching degree between the vein image and any one of the authorized vein images is lower than a preset threshold.

19. The wearable terminal according to claim 18, wherein the preset threshold is 90%, 80% or 60%.
